(19) United States
(12) Patent Application Publication
(10) Pub. No.: US 2025/0272567 A1
(43) Pub. Date: Aug. 28, 2025

(54) NIMBLE AND MODIFIABLE OUTER LAYER FOR FOUNDATIONAL GENERATIVE ARTIFICIAL INTELLIGENCE (AI) MODELS TO DELAY MODEL DECAY AND EXTEND MODEL LIFE

(71) Applicant: Bank of America Corporation, Charlotte, NC (US)

(72) Inventor: Maharaj Mukherjee, Poughkeepsie, NY (US)

(21) Appl. No.: 18/589,754

(22) Filed: Feb. 28, 2024

(51) Int. Cl. G06N 3/091; G06N 3/0475

(52) U.S. Cl. CPC G06N 3/091; G06N 3/0475

(57) ABSTRACT

A computing platform may train, using historical information, a closed loop foundational generative AI model to generate responses to input prompts. The computing platform may receive, after training and deploying of the foundational generative AI model is complete, updated information that may be relevant to the generation of the responses. The computing platform may train, based on the updated information, an outer layer model that is dynamically updatable to evaluate the responses from the foundational generative AI model and to modify incorrect responses. The computing platform may input a first input prompt into the foundational generative AI model to produce an initial response. The computing platform may input the initial response into the outer layer model. Based on identifying, using the outer layer model, that the initial response is incorrect, the computing platform may modify the initial response to produce a modified response; and send the modified response for display.

### BACKGROUND

In some instances, enterprise organizations may utilize generative artificial intelligence (AI) models to provide information to customers and/or employees (e.g., through chatbots, or the like). Such generative AI models may, in some instances, be closed loop models that are not dynamically updated. As a result, over time, the models may reduce in their accuracy due to information drift, concept drift, or the like. Accordingly, it may be important to reduce the effects of such drift on the generative AI models to provide increased accuracy for an extended period of time.

### SUMMARY

Aspects of the disclosure provide effective, efficient, scalable, and convenient technical solutions that address and overcome the technical problems associated with maintaining generative artificial intelligence models. In accordance with one or more embodiments of the disclosure, a computing platform comprising at least one processor, a communication interface, and memory storing computer-readable instructions may train, using historical information, a foundational generative AI model, which may configure the foundational generative AI model to generate responses to input prompts, and where the foundational generative AI model may be a closed loop model. The computing platform may receive, after training and deploying of the foundational generative AI model is complete, updated information, which may be relevant to the generation of the responses. The computing platform may train, based on the updated information, an outer layer model, which may be dynamically updatable, and where training the outer layer model may configure the outer layer model to evaluate the responses from the foundational generative AI model and to modify incorrect responses. The computing platform may receive, from a user device, a first input prompt. The computing platform may input the first input prompt into the foundational generative AI model to produce an initial response. The computing platform may input the initial response into the outer layer model. Based on identifying, using the outer layer model, that the initial response is incorrect, the computing platform may modify the initial response to produce a modified response, and send the modified response to the user device for display.

In one or more instances, based on identifying, using the outer layer model, that the initial response is correct, the computing platform may route the initial response to one or more adaptation models. In one or more instances, the one or more adaptation models may each be trained to provide responses in a corresponding context.

In one or more examples, the corresponding context may include one of: question answering, sentiment analysis, information extraction, image captioning, object recognition, or instruction following. In one or more examples, the computing platform may identify, using the one or more adaptation models, whether the initial response is correct. Based on identifying that the initial response is correct, the computing platform may send, to the user device, the initial response and one or more commands directing the user device to display the initial response, which may cause the user device to display the initial response. Based on identifying that the initial response is incorrect, the computing platform may send negative feedback, indicating the incorrect response, to an administrator device.

In one or more instances, sending the modified response to the user device for display may include sending, after validating the modified response at one or more adaptation models, the modified response. In one or more instances, feedback from one or more adaptation models may be used to dynamically refine the outer layer model.

In one or more examples, identifying, by the outer layer model, that the initial response is incorrect may include: 1) identifying that more than a predetermined number of incorrect responses have been received from the foundational generative AI model during a predetermined time period, and 2) based on identifying that more than the predetermined number of incorrect response have been received, causing the foundational generative AI model to be decommissioned and rebuilt. In one or more examples, the computing platform may automatically rebuild the foundational generative AI model based on feedback from one or more of: the outer layer model or one or more adaptation models. In one or more examples, the outer layer model may extend a functional life of the foundational generative AI model.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for using a nimble outer layer model to delay model decay for foundational generative artificial intelligence models in accordance with one or more example embodiments.

FIGS. 2A-2E depict an illustrative event sequence for using a nimble outer layer model to delay model decay for foundational generative artificial intelligence models in accordance with one or more example embodiments.

FIG. 3 depicts an illustrative method for using a nimble outer layer model to delay model decay for foundational generative artificial intelligence models in accordance with one or more example embodiments.

FIGS. 4 and 5 depict illustrative user interfaces for using a nimble outer layer model to delay model decay for foundational generative artificial intelligence models in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to using a nimble outer layer model to delay model decay for foundational generative artificial intelligence models. Model drift (also known as model decay) refers to the degradation of a model's prediction power due to changes in the environment, and thus the relationships between variables. Changes in the presentation of spam emails may cause fraudulent detection models created several years ago to degrade. Concept drift or hypothesis drift is a type of model drift where the properties of the dependent variable changes. The fraudulent model described above may be an example of concept drift, where the classification of what is fraudulent changes. Data drift is a type of model drift where the properties of the independent variables change. Example of such data drift include changes in the data due to seasonality, changes in consumer preferences, the addition of new products, or the like.

The most accurate way to detect model drift may be to compare predicted values from a given machine learning model to the actual values. The accuracy of a model may worsen as the predicted values deviate farther and farther from the actual values. A common metric used to evaluate the accuracy of a model among data scientists is the F1 score, mainly because it encompasses both the precision and recall of the model. That being said, there may be a number of other relevant metrics depending on the situation. When a specified metric falls below a given threshold, the corresponding model is drifting.

Unlike traditional AI models, the foundation models are very large and complex, and take a lot of hardware and human resources to build. As a rule of thumb, the more complex a model is, the more susceptible it may be to decay. There is currently no obvious way to prevent model decay in generative AI, other than building (or rebuilding) the model completely from scratch.

Accordingly, described herein is a nimble modifiable outer layer for foundational models in generative AI to delay model decay and extend model life. This outer layer may be based on more recent data than the original foundation layer. The outer layer may be built using machine learning technology. The outer layer may also monitor its decay and correct itself against decay. It may make older data obsolete, and ingest newer data in its place regularly. When the foundational model generates a response, the outer layer may check the validity of the response and modify the response if needed based on the current context of updated data. The outer layer may also provide feedback to the foundation layer which can recluster if needed. It may also provide feedback received from adapted models to the foundational model, and based on this feedback, the foundational model may recluster as needed. The outer layer may also provide feedback on a status of the foundational model to an administrator who may decide when it may be necessary to build a completely new foundational model.

These and other features are described in greater detail below.

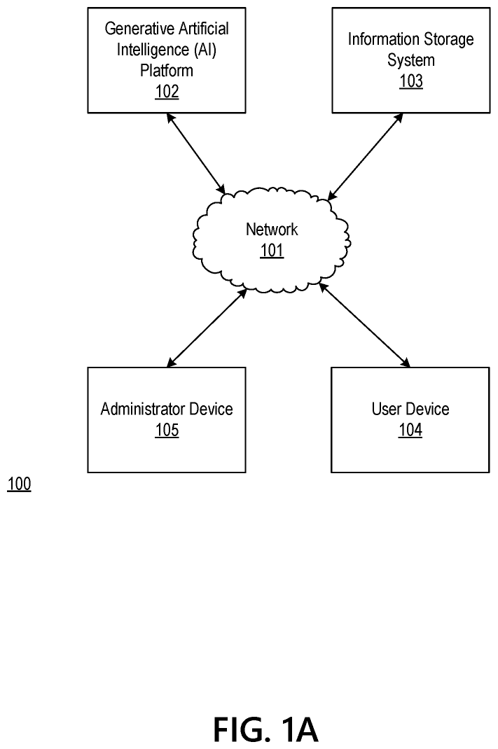

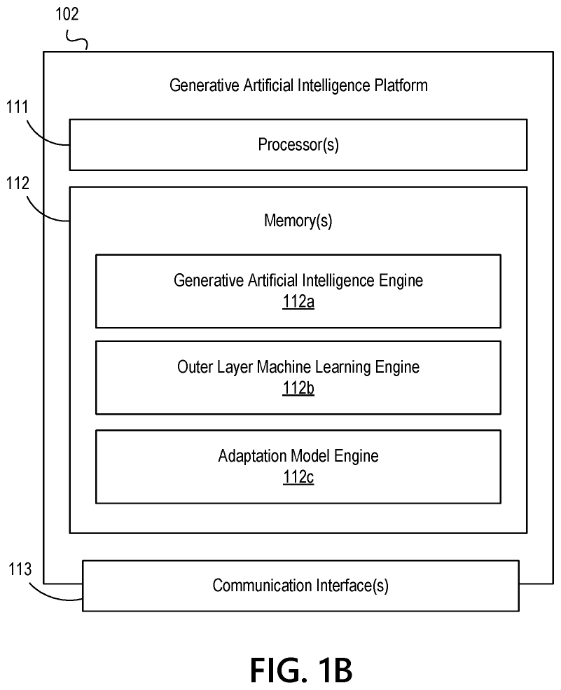

FIGS. 1A-1B depict an illustrative computing environment for using a nimble outer layer model to delay model decay for foundational generative artificial intelligence models in accordance with one or more example embodiments. Referring to FIG. 1A, computing environment 100 may include one or more computer systems. For example, computing environment 100 may include generative AI platform 102, information storage system 103, user device 104, and administrator device 105.

Generative AI platform 102 may include one or more computing devices (servers, server blades, or the like) and/or other computer components (e.g., processors, memories, communication interfaces, or the like). For example, the generative AI platform 102 may be configured to train, host, and apply a foundational generative AI model, configured to produce outputs in response to inputs, or the like. In some instances, the generative AI platform 102 may also be configured to train, host, and apply an outer layer model, configured to evaluate and/or correct responses from the foundational generative AI model. In some instances, the generative AI platform 102 may also be configured to train, host, and/or apply one or more adaptation models, configured to produce outputs in response to inputs based on and/or otherwise corresponding to a particular context (e.g., in contrast to the general context of the foundational generative AI model). While the foundational generative AI model may be a closed loop model, the outer layer model and/or the adaptation models may be dynamically updated based on new information.

Information storage system 103 may be or include one or more computing devices (e.g., servers, server blades, or the like) and/or other computer components (e.g., processors, memories, communication interfaces, or the like). For example, information storage system 103 may be configured to store information such as text information, images, speech information, structured information, three dimensional signals, literature information, cultural information, social information, geographical information, legal information, linguistic information, and/or other information. In these instances, the information storage system 103 may be configured to send such information to the generative AI platform 102 for the purpose of training the foundational generative AI model, outer layer model, and/or adaptation models. Any number of such information storage devices may be used to implement the techniques described herein without departing from the scope of the disclosure.

User device 104 may be or include one or more devices (e.g., laptop computers, desktop computer, smartphones, tablets, and/or other devices) configured for use in communicating with a generative AI model. For example, the user device 104 may be used to send prompts/inputs to the generative AI platform 102, and to receive responses that have been validated by the outer layer model and/or adaptation models. In some instances, the user device 104 may be configured to display one or more graphical user interfaces (e.g., validated output interfaces, or the like), which may, e.g., be used to provide feedback on outputs, initiate model reconfigurations, or the like. Any number of such user devices may be used to implement the techniques described herein without departing from the scope of the disclosure.

Administrator device 105 may be or include one or more devices (e.g., laptop computers, desktop computer, smartphones, tablets, and/or other devices) configured for use in monitoring a status of and/or otherwise updating the models at the generative AI platform 102. For example, the administrator device 105 may be used to initiate reconfigurations of the foundational generative AI model, outer layer mode, adaptation models, or the like. In some instances, the administrator device 105 may be configured to display one or more graphical user interfaces (e.g., notifying that a reconfiguration should be performed, or the like). Any number of such user devices may be used to implement the techniques described herein without departing from the scope of the disclosure.

Computing environment 100 also may include one or more networks, which may interconnect generative AI platform 102, information storage system 103, user device 104, and administrator device 105. For example, computing environment 100 may include a network 101 (which may interconnect, e.g., generative AI platform 102, information storage system 103, user device 104, and administrator device 105).

In one or more arrangements, generative AI platform 102, information storage system 103, user device 104, and administrator device 105 may be any type of computing device capable of receiving a user interface, receiving input via the user interface, and communicating the received input to one or more other computing devices, and/or training, hosting, executing, and/or otherwise maintaining one or more artificial intelligence models. For example, generative AI platform 102, information storage system 103, user device 104, administrator device 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of generative AI platform 102, information storage system 103, user device 104, and administrator device 105 may, in some instances, be special-purpose computing devices configured to perform specific functions.

Referring to FIG. 1B, generative AI platform 102 may include one or more processors 111, memory 112, and communication interface 113. A data bus may interconnect processor 111, memory 112, and communication interface 113. Communication interface 113 may be a network interface configured to support communication between generative AI platform 102 and one or more networks (e.g., network 101, or the like). Memory 112 may include one or more program modules having instructions that when executed by processor 111 cause generative AI platform 102 to perform one or more functions described herein and/or one or more databases that may store and/or otherwise maintain information which may be used by such program modules and/or processor 111. In some instances, the one or more program modules and/or databases may be stored by and/or maintained in different memory units of generative AI platform 102 and/or by different computing devices that may form and/or otherwise make up generative AI platform 102. For example, memory 112 may have, host, store, and/or include generative artificial intelligence engine 112a, outer layer machine learning engine 112b, and adaptation model engine 112c. Generative artificial intelligence engine 112a may have instructions that direct and/or cause generative AI platform 102 to train, host, and/or otherwise execute a generative AI model to produce responses. Outer layer machine learning engine 112b may have instructions that direct and/or cause generative AI platform 102 to train, host, maintain, and/or otherwise apply a machine learning model to validate and/or otherwise modify outputs of the generative artificial intelligence model. Adaptation model engine 112c may have instructions that direct and/or cause generative AI platform 102 to train, host, maintain, and/or otherwise apply one or more adaptation models to utilize the outputs of the outer layer model to produce verified responses to a user, and/or to provide feedback on quality and/or performance of the generative artificial intelligence model and/or outer layer model.

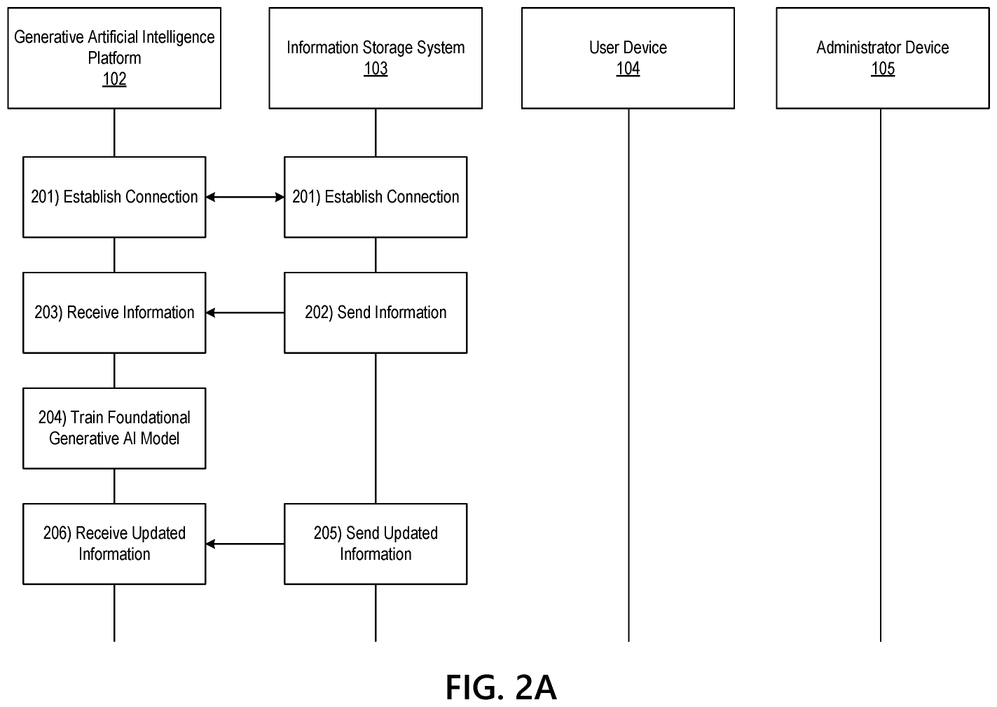

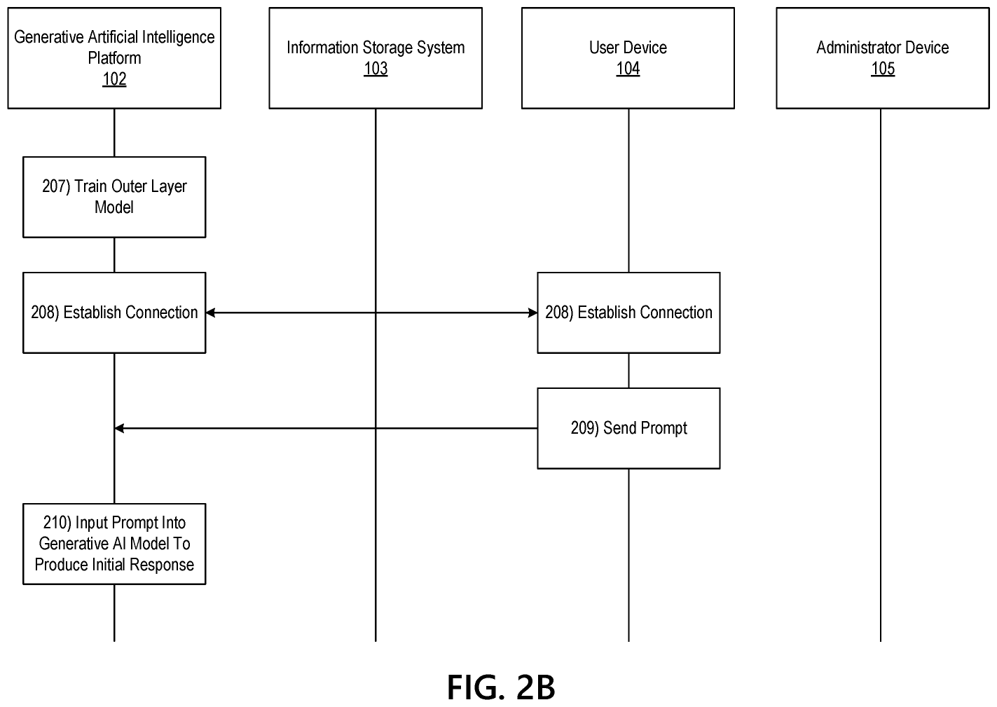

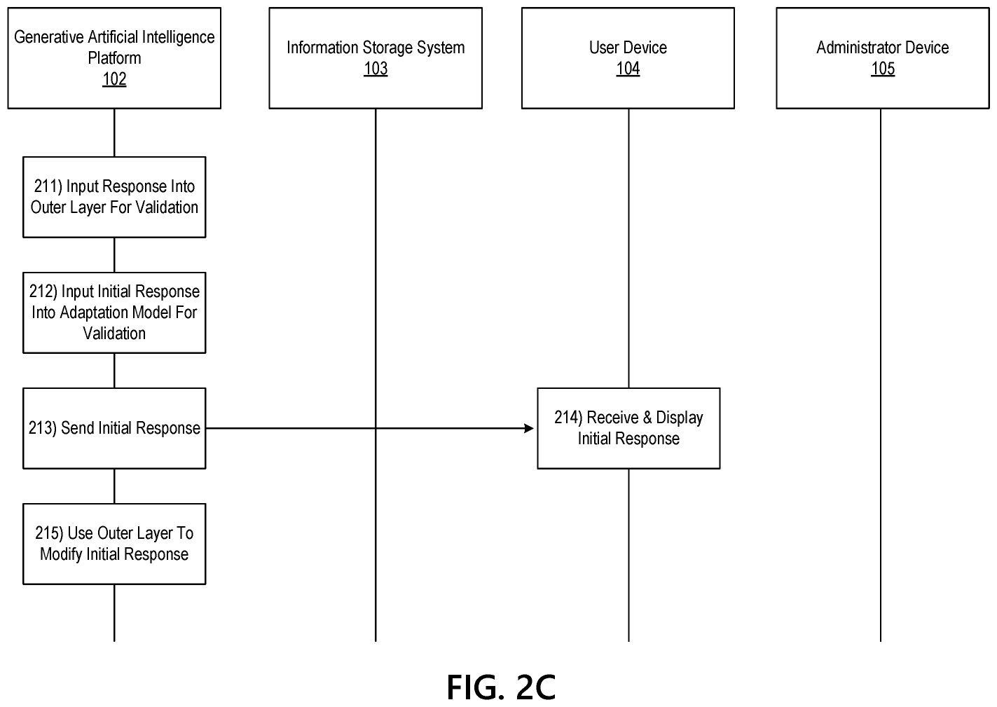

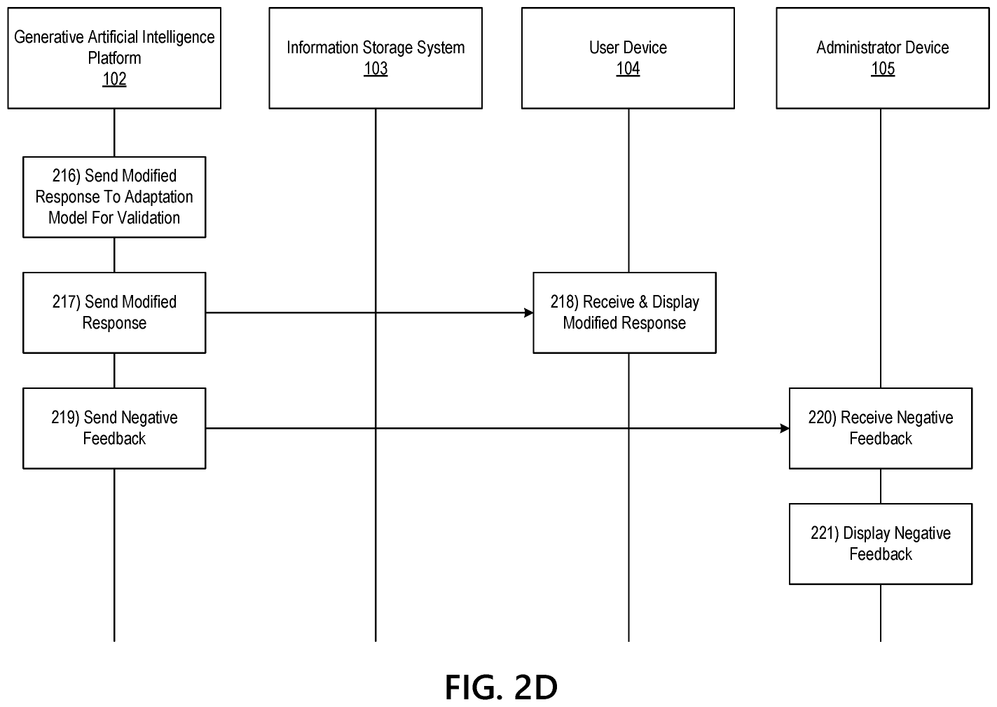

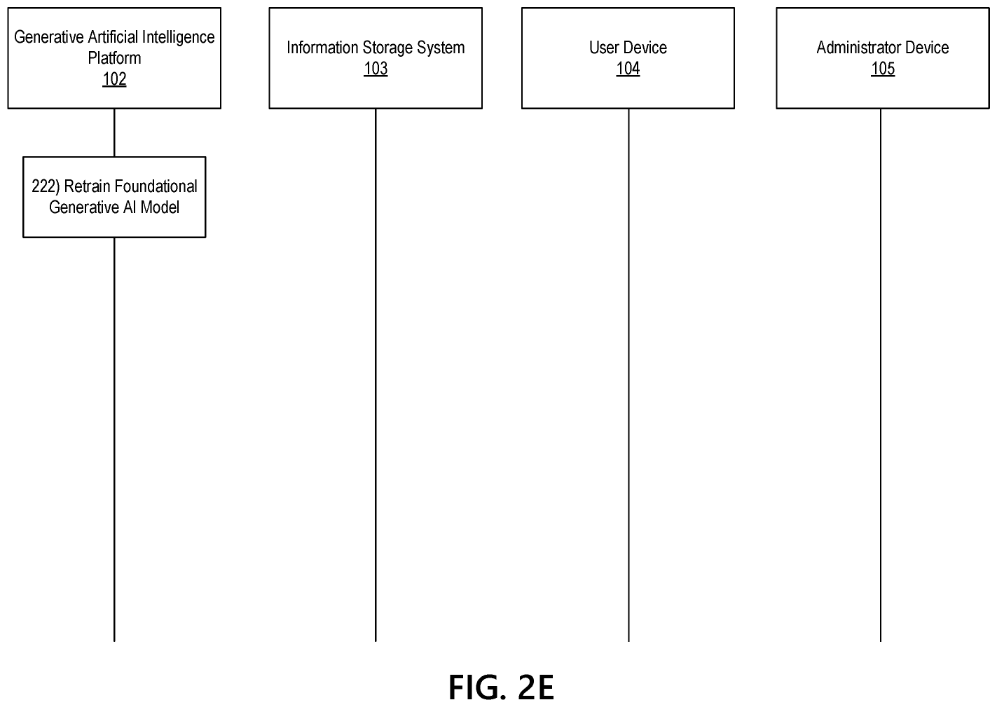

FIGS. 2A-2E depict an illustrative event sequence for using a nimble outer layer model to delay model decay for foundational generative artificial intelligence models in accordance with one or more example embodiments. Referring to FIG. 2A, at step 201, the information storage system 103 may establish a connection with the generative AI platform 102. For example, the information storage system 103 may establish a first wireless data connection with the generative AI platform 102 to link the information storage system 103 with the generative AI platform 102 (e.g., in preparation for sending information that may be used to train a foundational generative AI model, an outer layer model, adaptation models, and/or other models). In some instances, the information storage system 103 may identify whether or not a connection is already established with the generative AI platform 102. If a connection is already established with the generative AI platform 102, the information storage system 103 might not re-establish the connection. Otherwise, if a connection is not yet established with the generative AI platform 102, the information storage system 103 may establish the first wireless data connection as described herein.

At step 202, the information storage system 103 may send historical information to the generative AI platform 102. For example, the information storage system 103 may send text information, images, speech information, structured information, three dimensional signals, literature information, cultural information, social information, geographical information, legal information, linguistic information, and/or other information. For example, the information storage system 103 may send the historical information to the generative AI platform 102 while the first wireless data connection is established.

At step 203, the generative AI platform 102 may receive the historical information sent at step 202. For example, the generative AI platform 102 may receive the historical information via the communication interface 113 and while the first wireless data connection is established.

At step 204, the generative AI platform 102 may train a foundational generative AI model. For example, the generative AI platform 102 may use one or more conventional techniques to train and/or otherwise obtain a generative AI model (e.g., corresponding to a chatbot, application program interface (API), website, search engine, or the like). In some instances, rather than training the foundational generative AI model, the foundational generative AI model may be open-sourced, vendor sourced, or the like. For example, this generative AI model may be configured to perform: generating human-like text, searching and retrieving information, summarizing text, performing classification, understanding natural language and answering questions, analyzing sentiment, filtering content, translating language, assisting with computer code, generating content for creative applications, and/or other functions based on an input prompt. In some instances, this foundational generative AI model may have been previously trained on a representation of training data to generate new content that may be similar to or inspired by existing data, and that may include human-like outputs such as natural language text, source code, images/videos, audio samples, and/or other outputs.

At step 205, the information source system may send updated information to the generative AI platform 102. For example, this updated information may be similar to the information received at step 203, but may be more current, up to date, subsequently generated or captured, or the like, and may illustrate a delta when compared against the historical information. In some instances, the information source system may send the updated information to the generative AI platform 102 while the first wireless data connection is established.

At step 206, the generative artificial intelligence platform 102 may receive the updated information sent at step 205. For example, the generative artificial intelligence platform 102 may receive the updated information via the communication interface 113 and while the first wireless data connection is established.

Referring to FIG. 2B, at step 207, the generative AI platform 102 may train the outer layer model. For example, the generative AI platform 102 may train the outer layer model to evaluate initial responses from the generative AI model, and to modify such responses accordingly.

In some instances, to perform such training, the generative AI platform 102 may use the updated information received at step 206. For example, the outer layer model may establish stored correlations between various pieces of information and whether or not they are current, up to date, or the like. In doing so, when an initial response is fed into the outer layer model, it may be validated against the updated information of the outer layer model. The outer layer model may further be configured to modify, in the event that the initial response is inconsistent with the updated information, the initial response, which may, e.g., make the initial response consistent with the updated information.

In some instances, the outer layer model may maintain an error rate (e.g., a number of responses needing modification over a predetermined period of time, or the like), and/or other metric representative of errors identified in responses from the foundational generative AI model. The outer layer model may be trained to compare this error rate against a predetermined threshold value, which may, e.g., allow the outer layer model to provide feedback on whether or not the foundational generative AI model needs to be rebuilt. For example, if the error rate meets or exceeds the threshold, the foundational generative AI model should be rebuilt, whereas if the error rate does not yet meet or exceed the threshold, the foundational generative AI model need not be rebuilt yet. In doing so, the outer layer model (which may e.g., be a nimble and dynamically updatable layer through which responses of the foundational generative AI model are fed) may extend the life of the foundational generative AI model by delaying the effects of information drift on model decay, despite the fact that the foundational generative AI model itself may be a closed loop model.

In some instances, in training the outer layer model, the generative AI platform 102 may use one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques.

Although training of the outer layer model is described at step 207, it should be understood that updated information may be received at any time throughout the event sequence described herein, and the outer layer model would update dynamically based on this new information.

At step 208, the user device 104 may establish a connection with the generative AI platform 102. For example, the user device 104 may establish a second wireless data connection with the generative AI platform 102 to link the user device 104 to the generative AI platform 102 (e.g., in preparation for sending prompts for processing). In some instances, the user device 104 may identify whether or not a connection is established with the generative AI platform 102. If a connection is already established with the generative AI platform 102, the user device 104 might not re-establish the connection. If a connection is not yet established with the generative artificial intelligence platform 102, the user device 104 may establish the second wireless data connection as described herein.

At step 209, the user device 104 may send a prompt to the generative AI platform 102. For example, the user device 104 may send a prompt configured for input into the foundational generative AI model. As a particular example, the user device 104 may enable a user to interact with a chatbot hosted by the generative AI platform 102 and/or otherwise, and the prompt may request a response by the chatbot. For example, the user device 104 may send the prompt to the generative AI platform 102 while the second wireless data connection is established.

At step 210, the generative AI platform 102 may produce an initial response. For example, the generative AI platform 102 may feed the prompt into the foundational generative AI model (e.g., a large language model corresponding to a chatbot, application program interface (API), website, search engine, or the like). In these instances, the foundational generative AI model may, based on the prompt, generate human-like text, search and retrieve information, summarize text, perform classification, understand natural language and answer questions, analyze sentiment, filter content, translate language, assist with computer code, generate content for creative applications, and/or perform other functions based on the prompt.

Referring to FIG. 2C, at step 211, the generative AI platform 102 may input the initial response of the foundational generative AI model into the outer layer model for validation and/or modification. For example, the outer layer model may identify a correlation between the initial response and information of the outer layer model, and may identify whether or not the corresponding information is out of date, incorrect, or the like based on updated information. If the initial response is out of date, incorrect, or the like, the outer layer model may update the stored error rate, and may proceed to step 215. If the initial response is correct, the generative AI platform may proceed to step 212.

At step 212, the generative AI platform 102 may input the initial response into one or more adaptation models for validation. For example, these adaptation models may be similarly trained, as is described above at step 207, as the outer layer model. However, whereas the foundational generative AI model and/or outer layer model may be general in nature (e.g., not corresponding to a particular topic, field, type of output, type of task, or the like), the adaptation models may be more specific. For example, the adaptation models may correspond to one or more of: question answering, sentiment analysis, information extraction, image captioning, object recognition, instruction following, or the like. Accordingly, as is described above at step 211 with regard to the outer layer model, the one or more adaptation models may validate the initial response. If the response is validated, the generative AI platform 102 may proceed to step 213. If the response is not validated, the generative AI platform 102 may proceed to step 219.

At step 213, the generative AI platform 102 may send the initial response to the user device 104. For example, the generative AI platform 102 may send the initial response to the user device 104 via the communication interface 113 and while the second wireless data connection is established. In some instances, the generative AI platform 102 may also send one or more commands directing the user device 104 to display the initial response.

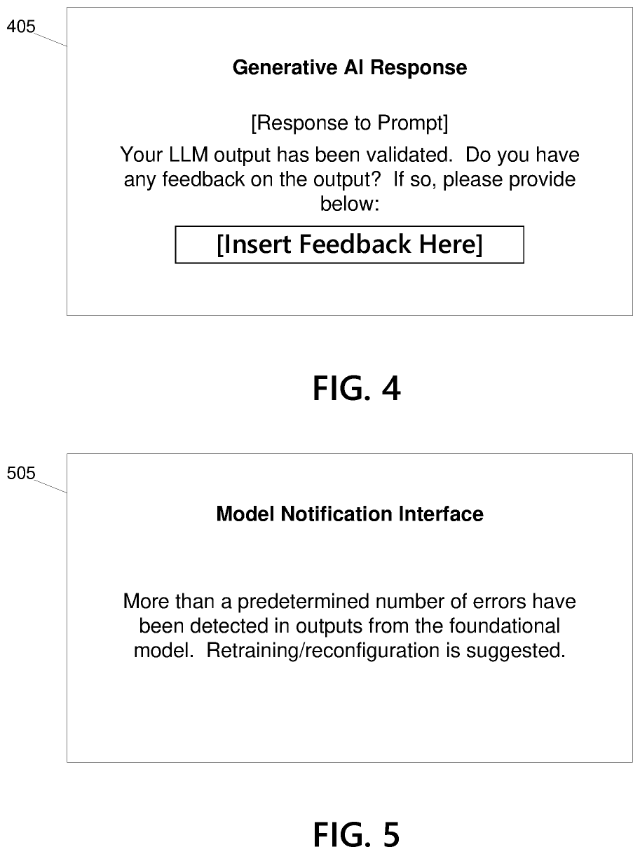

At step 214, the user device 104 may receive the initial response. For example, the generative AI platform 102 may receive the initial response while the second wireless data connection is established. In some instances, the user device 104 may also receive the one or more commands directing the user device 104 to display the initial response. In these instances, based on or in response to the one or more commands directing the user device 104 to display the initial response, the user device 104 may display the initial response. For example, the user device 104 may display a graphical user interface similar to graphical user interface 405, which is illustrated in FIG. 4.

Returning to step 211, if the outer layer model identified an error in the initial response, the generative AI platform 102 may have proceeded to step 215. At step 215, the outer layer model may adjust the response accordingly (e.g., based on corresponding updated information) to produce a modified response. For example, in doing so, the outer layer model may cause an response of the foundational generative AI model to be modified based on information that may be more recent/current than information used to initially configure the foundational generative AI model.

Referring to FIG. 2D, at step 216, the generative AI platform 102 may send the modified response to the one or more adaptation models for validation, and they may validate the modified response accordingly (e.g., as is described above at step 212). If the modified response is validated, the generative AI platform 102 may proceed to step 217. If the modified response is not validated, the generative AI platform 102 may proceed to step 219.

At step 217, the generative AI platform 102 may send the modified response to the user device 104. For example, the generative AI platform 102 may send the modified response to the user device 104 via the communication interface 113 and while the second wireless data connection is established. In some instances, the generative AI platform 102 may also send one or more commands directing the user device 104 to display the modified response.

At step 218, the user device 104 may receive and display the modified response. For example, the user device 104 may receive the modified response while the second wireless data connection is established. In some instances, the user device 104 may also receive the one or more commands directing the user device to display the modified response. In these instances, based on or in response to the one or more commands directing the user device to display the modified response, the user device 104 may display the modified response (which may, e.g., be similar to graphical user interface 405, as is described above).

Returning to steps 212 and 216, if the adaptation models did not validate the initial and/or modified response, the generative AI platform 102 may have proceeded to step 219. At step 219, the generative AI platform 102 may send negative feedback to the administrator device 105 indicating that an error was detected. Furthermore, based on this error identification, the generative AI platform 102 may update the stored error rate. In some instances, the generative AI platform 102 may include the stored error rate in the negative feedback. In some instances, the generative AI platform 102 may send the negative feedback to the administrator device 105 via the communication interface 113 and while a third wireless data connection is established with the administrator device 105 (for example, the generative AI platform 102 may have previously established, or may establish at this step, such a connection for the purpose of sharing feedback between the generative AI platform 102 and the administrator device 105). In some instances, the generative AI platform 102 may also send one or more commands directing the administrator device 105 to display the negative feedback. In some instances, the user device 104 may also be notified of an error in the processing of their prompt. In some instances, this negative feedback may further be used to update the outer layer model (e.g., via a dynamic feedback loop), which may e.g., enable the outer layer model to continuously and dynamically improve based on feedback received from the adaptation models.

At step 220, the administrator device 105 may receive the negative feedback sent at step 219. For example, the administrator device 105 may receive the negative feedback while the third wireless data connection is established. In some instances, the administrator device 105 may also receive the one or more commands directing the administrator device 105 to display the negative feedback.

At step 221, based on or in response to the one or more commands directing the administrator device 105 to display the negative feedback, the administrator device 105 may display the negative feedback. For example, the administrator device 105 may display a graphical user interface similar to the graphical user interface 505, which is illustrated in FIG. 5.

With reference to FIG. 2E, at step 222, the generative AI platform 102 may initiate a rebuild, reconfiguration, or the like of the foundational generative AI model, and/or the outer layer model. For example, in some instances, this may be automatically initiated based on detecting that the error rate exceeds a predetermined threshold value, and/or based on other feedback from the outer layer model and/or the one or more adaptation models. Additionally or alternative, this may be initiated based on feedback from the administrator device 105. By operating in this way, however, although the foundational generative AI model may ultimately need to be rebuilt, the functional life of the model may be extended through the use of the nimble and dynamically updatable outer layer model. Doing so may reduce costs (both computing and monetary) of rebuilding the models, enhance and ensure model accuracy for an extended period of time, and reduce downtime where the model is taken offline for reconfiguration.

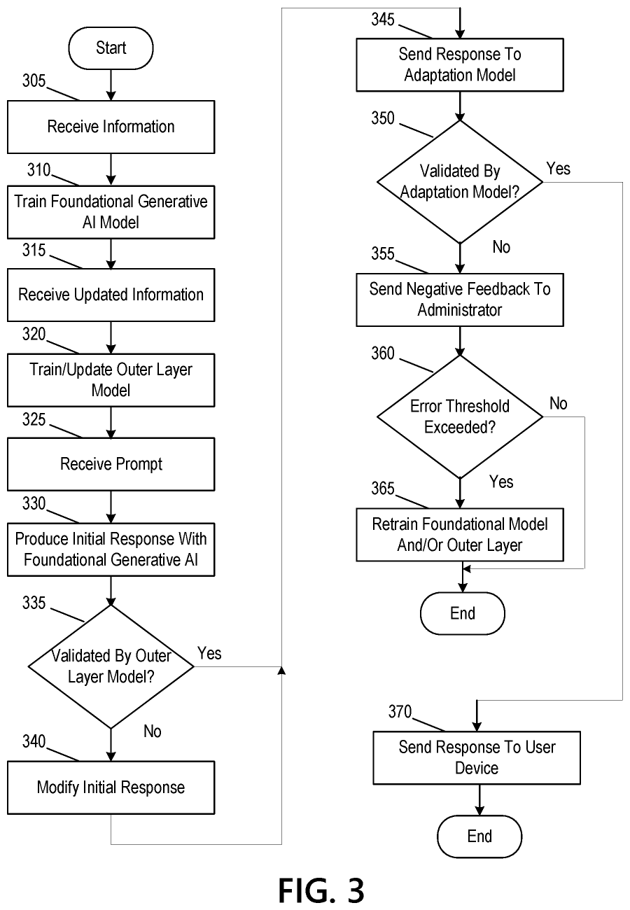

FIG. 3 depicts an illustrative method for using a nimble outer layer model to delay model decay for foundational generative artificial intelligence models in accordance with one or more example embodiments. Referring to FIG. 3, at step 305, a computing platform comprising one or more processors, memory, and a communication interface may receive information. At step 310, the computing platform may train a foundational generative AI model. At step 315, the computing platform may receive updated information. At step 320, the computing platform may train and/or update an outer layer model. At step 325, the computing platform may receive a prompt. At step 330, the computing platform may produce an initial response using the foundational generative AI model. At step 335, the computing platform may attempt to validate the initial response using the outer layer model. If the response is not validated, the computing platform may proceed to step 340. At step 340, the computing platform may modify the initial response, and proceed to step 345.

Otherwise, if the computing platform was able to successfully validate the response at step 335, the computing platform may proceed directly to step 345. At step 345, the computing platform may send the response to an adaptation model. At step 350, the computing platform may identify whether or not the response is validated by the adaptation model. If the response is not validated by the adaptation model, the computing platform may proceed to step 355. At step 355, the computing platform may send negative feedback to an administrator of the computing platform. At step 360, the computing platform may identify whether or not an error threshold is exceeded. If the error threshold is not met or exceeded, the method may end. Otherwise, if the error threshold is met or exceeded, the computing platform may proceed to step 365. At step 365, the computing platform may retrain the foundational model and/or the outer layer model.

Returning to step 350, if the computing platform identified that the response was validated by the adaptation model, the computing platform may proceed to step 370. At step 370, the computing platform may send the response to a user device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, using historical information, a foundational generative AI model, wherein training the foundational generative AI model configures the foundational generative AI model to generate responses to input prompts, wherein the foundational generative AI model is a closed loop model;
receive, after training and deploying of the foundational generative AI model is complete, updated information, wherein the updated information is relevant to the generation of the responses;
train, based on the updated information, an outer layer model, wherein the outer layer model comprises a model that is dynamically updatable, and wherein training the outer layer model configures the outer layer model to evaluate the responses from the foundational generative AI model and to modify incorrect responses;
receive, from a user device, a first input prompt;
input the first input prompt into the foundational generative AI model to produce an initial response;
input the initial response into the outer layer model; and
based on identifying, using the outer layer model, that the initial response is incorrect:
modify the initial response to produce a modified response; and
send the modified response to the user device for display.

2. The computing platform of claim 1, wherein the memory stores additional computer readable instructions that, when executed by the at least one processor, cause the computing platform to:
based on identifying, using the outer layer model, that the initial response is correct, route the initial response to one or more adaptation models.

3. The computing platform of claim 2, wherein the one or more adaptation models are each trained to provide responses in a corresponding context.

4. The computing platform of claim 3, wherein the corresponding context comprises one of: question answering, sentiment analysis, information extraction, image captioning, object recognition, or instruction following.

5. The computing platform of claim 2, wherein the memory stores additional computer readable instructions that, when executed by the at least one processor, cause the computing platform to:
identify, using the one or more adaptation models, whether the initial response is correct;
based on identifying that the initial response is correct, send, to the user device, the initial response and one or more commands directing the user device to display the initial response, wherein sending the one or more commands directing the user device to display the initial response causes the user device to display the initial response; and
based on identifying that the initial response is incorrect, send negative feedback, indicating the incorrect response, to an administrator device.

6. The computing platform of claim 1, wherein sending the modified response to the user device for display comprises sending, after validating the modified response at one or more adaptation models, the modified response.

7. The computing platform of claim 1, wherein feedback from one or more adaptation models is used to dynamically refine the outer layer model.

8. The computing platform of claim 1, wherein identifying, by the outer layer model, that the initial response is incorrect further comprises:
identifying that more than a predetermined number of incorrect responses have been received from the foundational generative AI model during a predetermined time period; and
based on identifying that more than the predetermined number of incorrect response have been received, causing the foundational generative AI model to be decommissioned and rebuilt.

9. The computing platform of claim 8, wherein the memory stores additional computer readable instructions that, when executed by the at least one processor, cause the computing platform to:
automatically rebuild the foundational generative AI model based on feedback from one or more of: the outer layer model or one or more adaptation models.

10. The computing platform of claim 1, wherein the outer layer model extends a functional life of the foundational generative AI model.

11. A method comprising:
at a computing platform comprising at least one processor, a communication interface, and memory:
training, using historical information, a foundational generative AI model, wherein training the foundational generative AI model configures the foundational generative AI model to generate responses to input prompts, wherein the foundational generative AI model is a closed loop model;
receiving, after training and deploying of the foundational generative AI model is complete, updated information, wherein the updated information is relevant to the generation of the responses;
training, based on the updated information, an outer layer model, wherein the outer layer model comprises a model that is dynamically updatable, and wherein training the outer layer model configures the outer layer model to evaluate the responses from the foundational generative AI model and to modify incorrect responses;
receiving, from a user device, a first input prompt;
inputting the first input prompt into the foundational generative AI model to produce an initial response;
inputting the initial response into the outer layer model; and
based on identifying, using the outer layer model, that the initial response is incorrect:
modifying the initial response to produce a modified response; and
sending the modified response to the user device for display.

12. The method of claim 11, further comprising:
based on identifying, using the outer layer model, that the initial response is correct, routing the initial response to one or more adaptation models.

13. The method of claim 12, wherein the one or more adaptation models are each trained to provide responses in a corresponding context.

14. The method of claim 13, wherein the corresponding context comprises one of:
question answering, sentiment analysis, information extraction, image captioning, object recognition, or instruction following.

15. The method of claim 12, further comprising:
identifying, using the one or more adaptation models, whether the initial response is correct;
based on identifying that the initial response is correct, sending, to the user device, the initial response and one or more commands directing the user device to display the initial response, wherein sending the one or more commands directing the user device to display the initial response causes the user device to display the initial response; and
based on identifying that the initial response is incorrect, sending negative feedback, indicating the incorrect response, to an administrator device.

16. The method of claim 11, wherein sending the modified response to the user device for display comprises sending, after validating the modified response at one or more adaptation models, the modified response.

17. The method of claim 11, wherein feedback from one or more adaptation models is used to dynamically refine the outer layer model.

18. The method of claim 11, wherein identifying, by the outer layer model, that the initial response is incorrect further comprises:
identifying that more than a predetermined number of incorrect responses have been received from the foundational generative AI model during a predetermined time period; and
based on identifying that more than the predetermined number of incorrect response have been received, causing the foundational generative AI model to be decommissioned and rebuilt.

19. The method of claim 18, further comprising:
automatically rebuilding the foundational generative AI model based on feedback from one or more of: the outer layer model or one or more adaptation models.

20. One or more non-transitory computer-readable media storing instructions that, when executed by a computing platform comprising at least one processor, a communication interface, and memory, cause the computing platform to:
train, using historical information, a foundational generative AI model, wherein training the foundational generative AI model configures the foundational generative AI model to generate responses to input prompts, wherein the foundational generative AI model is a closed loop model;
receive, after training and deploying of the foundational generative AI model is complete, updated information, wherein the updated information is relevant to the generation of the responses;
train, based on the updated information, an outer layer model, wherein the outer layer model comprises a model that is dynamically updatable, and wherein training the outer layer model configures the outer layer model to evaluate the responses from the foundational generative AI model and to modify incorrect responses;
receive, from a user device, a first input prompt;
input the first input prompt into the foundational generative AI model to produce an initial response;
input the initial response into the outer layer model; and
based on identifying, using the outer layer model, that the initial response is incorrect:
modify the initial response to produce a modified response; and
send the modified response to the user device for display.
